(19) United States
(12) Patent Application Publication
(10) Pub. No.: US 2026/0150867 A1
(43) Pub. Date: Jun. 4, 2026

(54) Vegetable Fortified Expanded Food Product and Method of Producing

(71) Applicant: General Mills, Inc., Minneapolis, MN (US)

(72) Inventors: Jesse Mortenson, Coon Rapids, MN (US); Alison Diley, Prescott, WI (US); Catherine A. La Patka, Minneapolis, MN (US); Douglas J. Novak, Big Lake, MN (US); Allison Pannek Thuleen, Minnetonka, MN (US); Goeran Walther, Plymouth, MN (US)

(21) Appl. No.: 19/123,216

(22) PCT Filed: Dec. 7, 2023
(86) PCT No.: PCT/US2023/082921

§ 371 Date: Apr. 22, 2025

Related U.S. Application Data
(60) Provisional application No. 63/431,346, filed on Dec. 9, 2022.

(51) Int. Cl. A23L 7/17; A23L 7/122; A23L 7/126; A23L 19/10

(52) U.S. Cl. CPC A23L 7/17; A23L 7/122; A23L 7/126; A23L 19/105

(57) ABSTRACT

A grain-based expanded food product comprises a base formulation and a vegetable powder component present in an amount from about 7% to about 11% by dry weight. The vegetable powder component includes at least one starch-containing tuber vegetable powder, at least one low-starch root vegetable powder, and at least one leafy green powder, wherein the vegetable powder component comprises at least about 10% starch. In preferred embodiments, the vegetable powder component comprises a combination of sweet potato powder, carrot powder and spinach powder. The food product can be a puffed breakfast cereal or a puffed snack. A method of producing a grain-based expanded food product comprises combining a base formulation with a vegetable powder component to form a dough and processing the dough in an extruder to form an extruded mass. The method can further comprise forming the extruded mass into pieces, which can be further processed.

### FIELD OF THE INVENTION

The invention generally pertains to a grain-based expanded food product such as a puffed breakfast cereal or a puffed snack. M ore particularly, the present invention relates to a grain-based expanded food product having a non-grain vegetable content and to a process for producing the grain-based expanded food product.

### BACKGROUND OF THE INVENTION

Puffed breakfast cereals and puffed snack products are highly convenient food products for consumers, but are typically grain-based and do not contain non-grain vegetables.

Many consumers, including parents of younger children (e.g., ages 2-12), desire food products that help incorporate more non-grain vegetables into a diet because non-grain vegetables are important sources of many nutrients. In fact, the U.S. Department of Agriculture recommends one consume between ⅔ cup to 4 cups of vegetables per day, depending upon the consumer's age and other factors.

### SUMMARY OF THE INVENTION

A grain-based expanded food product comprises a base formulation and a vegetable powder component present in an amount from about 7% to about 11% by dry weight of the grain-base expanded food product. The vegetable powder component includes at least one starch-containing tuber vegetable powder, at least one low-starch root vegetable powder, and at least one leafy green powder, wherein the vegetable powder component comprises at least about 10% starch. In preferred embodiments, the vegetable powder component comprises a combination of sweet potato powder, carrot powder and spinach powder. In some embodiments, the ratio of starch-containing tuber vegetable powder to low-starch root vegetable powder to leafy green vegetable powder (e.g., sweet potato powder to carrot powder to spinach powder) in the vegetable powder component is about 4:2:1.

In some embodiments, the food product has a density between about 130 and about 180 grams per 100 cubic inches. The food product can be a puffed breakfast cereal or a puffed snack and can further comprise a coating (e.g., a sugar slurry coating).

A method of producing a grain-based expanded food product is also provided, where the method comprises combining a base formulation with a vegetable powder component to form a dough. The vegetable powder component is present in an amount from about 7% to about 11% by dry weight of the grain-base expanded food. The vegetable powder component includes at least one starch-containing tuber vegetable powder, at least one low-starch root vegetable powder, and at least one leafy green powder, wherein the vegetable powder component comprises at least about 10% starch. The method further comprises processing the dough in an extruder to form an extruded mass. Forming the extruded mass can include puffing the dough.

In some embodiments, the method further comprises forming the extruded mass into pieces (e.g., pellets, by cutting). In some embodiments, the pieces are then puffed (e.g., using a puffing gun). The method can further include drying and/or coating the pieces with a coating (e.g., a sugar slurry coating).

### DETAILED DESCRIPTION

Initially, it should be noted that the embodiments of the present invention described below are not intended to be exhaustive or limit the invention to the precise forms disclosed in the following detailed description. Rather, a purpose of the embodiments chosen and described is so that the appreciation and understanding by others skilled in the art of the principles and practices of the present invention can be facilitated. Also, it should be realized that the embodiments described in the below paragraphs for the inventive process, system and/or product are not mutually exclusive and therefore can be combined in connection with other embodiments.

Throughout the present description, unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

There is an ever-growing demand from consumers that want to generally incorporate more non-grain vegetables into their, or their children's, diet in a way that is convenient. While expanded food products such as puffed breakfast cereals or puffed snacks are convenient (e.g., shelf-stable, no refrigeration), conventional expanded food products contain insufficient or no amounts of non-grain vegetables (“vegetables”). Insufficient amounts of vegetables are those amounts that do not yield a product having a claimable serving of vegetables (e.g., ¼ cup of vegetables per serving). To reach a claimable amount of vegetables in an expanded grain-based food product (“vegetable-fortified expanded food product”), the inventors add a vegetable powder component to a base formulation. Moreover, the present inventors add specific vegetable powders in particular ratios/amounts to achieve an optimum amount of starch (e.g., at least about 10% and more preferably about 15%) needed to obtain puffing of the food product. The resulting expanded food product also has a sufficient density and a good balance of flavor.

A grain-based expanded food product in accordance with the present invention comprises a base formulation and a vegetable powder component. In some embodiments, the base formulation includes an oat-based ingredient and a corn-based and/or rice-based ingredient. The oat-based ingredient can include oat flour and/or whole-grain oat flour and/or be present in an amount from about 35% to about 45% by weight of the grain-based expanded food product and the corn-based and/or rice-based ingredient can include corn or rice flour and/or whole-grain corn or rice flour and/or be present in an amount from about 35% to about 45% by weight of the grain-based expanded food product. In some embodiments, the oat-based ingredient is the ingredient present in the highest percentage in the grain-based expanded food product.

The vegetable powder component is present in an amount from about 7% to about 11% (e.g., about 9%) by dry weight of the grain-based expanded food product. This amount of vegetable powder component is sufficient to achieve about ¼ cup of vegetables per serving of the grain-based expanded food product, not including any corn-based ingredient that may be in the base formulation. In some embodiments, a serving of the grain-based expanded food product is about 1 cup in volume and/or about 37 g in weight. In some embodiments, a serving of the grain-based expanded food product is about 1.25 cup in volume and/or about 41 g in weight. The vegetable powder component of the present invention contains vegetables that are acceptable to consumers and importantly contains a sufficient amount of starch (e.g., a least about 10% and, more preferably, about 15%) to allow for traditional expansion processing of the ingredients and yield a grain-based expanded food product having acceptable color, balanced and acceptable flavor and a desired density. A vegetable powder component with an insufficient amount of starch (e.g., less than about 10%) does not yield the above-mentioned desired properties. In some embodiments, the vegetable powder component includes at least one starch-containing tuber vegetable powder (e.g., sweet potato, potato, yam or cassava powder), at least one low-starch root vegetable (e.g., carrot powder, artichoke powder), and at least one leafy green vegetable (e.g., spinach or kale powder). In preferred embodiments, the vegetable powder component comprises a combination of sweet potato powder, carrot powder and spinach powder. In some embodiments, the ratio of starch-containing tuber vegetable powder to low-starch root vegetable powder to leafy green vegetable powder (e.g., sweet potato powder to carrot powder to spinach powder) in the vegetable powder component is about 4:2:1. In some embodiments, the starch-containing tuber vegetable powder (e.g., sweet potato powder) is present in an amount from about 55% to about 65% (e.g., about 58%) by weight of the vegetable powder component, the low-starch root vegetable (e.g., carrot powder) is present in an amount from about 25% to about 35% (e.g., about 28%) by weight of the vegetable powder component and the leafy green vegetable powder (e.g., spinach powder) is present in an amount from about 10% to about 20% (e.g., about 14%) by weight of the vegetable powder component.

In some embodiments, the grain-based expanded food product further comprises additional ingredients such as water, corn starch and/or other minor ingredients such as flavorants (e.g., natural flavors) or colorants (e.g., natural colors). In some embodiments, corn starch can be present in an amount of about from about 2% to about 6% (e.g., about 4%) by weight of the grain-based expanded food product.

The grain-based expanded food product can have an uncoated density between about 130 and about 180 grams per 100 cubic inches. In some embodiments, the grain-based expanded food product is a puffed breakfast cereal or a puffed snack. The grain-based expanded food product can assume various shapes such as round or “O” shapes or other shapes obtained by direct expansion extrusion processes. In some embodiments, the grain-based expanded food product further comprises a coating (e.g., a sugar slurry coating). It is to be understood that, in some cases, the addition of a coating can increase the density of a grain-based expanded food product to a density that is greater than 180 grams per 100 cubic inches.

A method of producing a grain-based expanded food product in accordance with the invention includes combining a base formulation with a vegetable powder component to form a dough. The base formulation and the vegetable powder component are described above. In some embodiments, the method further includes combining additional ingredients such as water, corn starch and/or other minor ingredients as described above, along with the base formulation and the vegetable powder component to form the dough.

The method further comprises processing the dough in an extruder to form an extruded mass. In some embodiments, the extruder is a traditional twin screw extruder used for direct expansion. In some embodiments, the base formulation and vegetable powder component (and possible additional ingredients, such as water) are combined within the extruder. The dough can be cooked in the extruder. Processing the dough in the extruder can include conveying and shearing the dough and pushing or pumping the dough through one or more openings of a die of the extruder to cause the dough to expand (e.g., puffing the dough; by pushing into an open space at ambient temperature and atmospheric pressure).

In some embodiments, the method further includes forming the extruded mass into pieces (e.g., pellets, by cutting). In some embodiments, the pieces are then puffed (e.g., using a puffing gun), for example, if the extruded mass was not already puffed when the pieces were formed. The formed pieces can assume various shapes such as round or “O” shapes or other shapes obtained by direct or indirect expansion extrusion processes. In some embodiments, the formed pieces can be dried and/or coated with a coating (e.g., a sugar slurry coating).

Although described with reference to particular embodiments of the invention, it should be understood that various changes and/or modifications can be made to the invention without departing therefrom as encompassed by the following claims. For example, although the most preferred embodiment of the invention employs sweet potato, carrot and spinach powders, other corresponding ingredients, i.e., at least one starch-containing tuber vegetable, at least one low-starch root vegetable and at least one leafy green vegetable, could be employed in the requisite ratio. For instance, other potatoes, yams, cassava and the like could be employed instead of sweet potato.

1. A grain-based expanded food product comprising
a base formulation; and
a vegetable powder component present in an amount from about 7% to about 11% by dry weight of the grain-base expanded food product and including:
at least one starch-containing tuber vegetable powder,
at least one low-starch root vegetable powder, and
at least one leafy green powder,
wherein the vegetable powder component comprises at least about 10% starch.

2. The food product of claim 1, wherein the at least one starch-containing tuber vegetable powder includes sweet potato powder, the at least one low-starch root vegetable powder includes carrot powder and the at least one leafy green powder includes spinach powder.

3. The food product of claim 1 or 2, wherein the sweet potato powder is present in an amount from about 55% to about 65% by weight of the vegetable powder component, the carrot powder is present in an amount from about 25% to about 35% by weight of the vegetable powder component and the spinach powder is present in an amount from about 10% to about 20% by weight of the vegetable powder component.

4. The food product of claim 1, wherein the ratio of at least one starch-containing tuber vegetable powder to at least one low-starch root vegetable powder to at least one leafy green vegetable powder in the vegetable powder component is about 4:2:1.

5. The food product of claim 1, wherein the base formulation includes an oat-based ingredient, a corn-based ingredient, or a rice-based ingredient.

6. The food product of claim 5, wherein the base formulation includes an oat-based ingredient and a corn-based ingredient.

7. The food product of claim 5, wherein the oat-based ingredient is the ingredient present in the highest percentage in the grain-based expanded food product.

8. The food product of claim 5, wherein the oat-based ingredient is present in an amount from about 35% to about 45% by weight of the grain-based expanded food product and the corn-based ingredient or rice-based ingredient is present in an amount from about 35% to about 45% by weight of the grain-based expanded food product.

9. The food product of claim 5, wherein the oat-based ingredient includes oat flour, the corn-based ingredient includes corn flour, and the rice-based ingredient includes rice flour.

10. The food product of claim 1, further comprising corn starch.

11. The food product of claim 1, wherein the corn starch is present in an amount from about 2% to about 6% by weight of the grain-based expanded food product.

12. The food product of claim 1, wherein the food product has a density between about 130 and about 180 grams per 100 cubic inches.

13. The food product of claim 1, wherein the food product is a puffed breakfast cereal or a puffed snack.

14. The food product of claim 1, further comprising a coating.

15. A method of producing a grain-based expanded food product, the method comprising combining a base formulation with a vegetable powder component to form a dough, wherein the vegetable powder component is present in an amount from about 7% to about 11% by dry weight of the grain-base expanded food product, the vegetable powder component includes at least one starch-containing tuber vegetable powder, at least one low-starch root vegetable powder, and at least one leafy green powder, and the vegetable powder comprises at least about 10% starch;
processing the dough in an extruder to form an extruded mass;
forming the extruded mass into pieces; and
puffing the pieces to form the grain-based expanded food product.

16. The method of claim 15, further comprising drying the pieces.

17. The method of claim 15, further comprising coating the pieces or dried pieces with a coating.
